(19) United States
(12) Patent Application Publication
(10) Pub. No.: US 2024/0237591 A1
(43) Pub. Date: Jul. 18, 2024

(54) BIODEGRADABLE LAYERED COMPOSITE

(71) Applicants: Samuel Edward Wortman, Lincoln, NE (US); Ignatius Kadoma, Cottage Grove, MN (US)

(72) Inventors: Samuel Edward Wortman, Lincoln, NE (US); Ignatius Kadoma, Cottage Grove, MN (US)

(21) Appl. No.: 18/416,576

(22) Filed: Jan. 18, 2024

Related U.S. Application Data
(60) Provisional application No. 63/466,033, filed on May 12, 2023.
(60) Provisional application No. 63/439,777, filed on Jan. 18, 2023.

(51) Int. Cl. A01G 13/02; A01G 9/029; A01G 13/00; A01G 24/46; B32B 3/26; B32B 5/02; B32B 29/02; B32B 37/16

(52) U.S. Cl. CPC A01G 13/0268; A01G 9/0291; A01G 24/46; B32B 3/266; B32B 5/022; B32B 29/02; B32B 37/16; A01G 2013/006; B32B 2262/02; B32B 2305/18; B32B 2307/40; B32B 2307/7163; B32B 2307/728; B32B 2307/73; B32B 2317/12; B32B 2410/00; B32B 2439/46

(57) ABSTRACT

A biodegradable layered composite includes at least a first layer and at least a second layer. The first layer of the biodegradable layered composite includes a paper layer having a top surface opposite a substantially planar and parallel bottom surface. The second layer of the biodegradable layered composite includes a non-woven polymer layer having a top surface opposite a substantially planar and parallel bottom surface. The non-woven polymer layer is bonded to the paper layer, forming the biodegradable layered composite. The biodegradable layered composite allows for at least one root of at least one seed to penetrate and grow through both of the paper layer and the non-woven polymer layer of the biodegradable layered composite.

### CROSS-REFERENCE TO RELATED APPLICATION

The present application claims the benefit of U.S. Provisional Application No. 63/439,777, filed on Jan. 18, 2023, and U.S. Provisional Application No. 63/466,033, filed on May 12, 2023, whereby each of the applications are incorporated herein by reference in their entirety.

### TECHNICAL FIELD

The present disclosure relates generally to a biodegradable layered composite, and, more particularly, to a biodegradable layered composite and method of use for allowing the roots of seeds to penetrate and grow through the biodegradable layered composite.

### BACKGROUND

In general, weeds can severely limit crop yield and quality, which can be especially problematic for organic farmers and home gardeners. In the absence of herbicides, typical options for managing weeds include tillage, mulch, or pulling by hand. Tillage, including tine and finger weeders, are popular among market gardeners and farmers, but can have negative side effects such as damaging the crop, reducing crop stands, and degrading soil health. Mulches, including plastic films and landscape fabrics, can be an effective option, but are only suitable for crops with wide spacing like tomato or cucumber. Also, weeds can still grow through mulch holes made during planting and reduce crop yield by 33%. Additionally, these products are often made from polyethylene or polypropylene plastic and must be either sent to a landfill or burned at the end of the growing season.

Further, tillage and mulches are not effective for direct seeded crops planted at high populations. For example, there is not enough space between plants for the mechanical disturbance of tillage, and the number of plant holes that would be required in mulch would render the mulch useless. As a result, hand weeding is almost unavoidable in high population organic vegetables, fruit, and cut flowers (e.g., carrot, spinach, spring mix lettuce, arugula, kale, mustard greens, onion, garlic, strawberry, zinnia, sunflower, and the like). For commercial growers, hand weeding may be an excessively expensive task depending on the crop and severity of weed infestation. For home gardeners, hand weeding is seen as an opportunity cost, which causes many to abandon gardening altogether. Therefore, there exists a need for an application, system, and method which cures one or more of the shortfalls of previous approaches identified above.

### SUMMARY

A biodegradable layered composite is disclosed, in accordance with one or more embodiments of the present disclosure. In one illustrative embodiment, the biodegradable layered composite includes at least one non-woven polymer layer having a top surface opposite a substantially planar and parallel bottom surface. In another illustrative embodiment, the biodegradable layered composite includes at least one paper layer disposed on the at least one non-woven polymer layer having a top surface opposite a substantially planar and parallel bottom surface. In another illustrative embodiment, one of the top or bottom surface of the at least one paper layer is bonded to one of the top or bottom surface of the at least one non-woven polymer layer. In another illustrative embodiment, the at least one non-woven polymer layer and the at least one paper layer allow for at least one root of at least one seed to penetrate through the at least one non-woven polymer layer and the at least one paper layer.

A method for manufacturing a biodegradable layered composite is disclosed, in accordance with one or more embodiments of the present disclosure. In one illustrative embodiment, the method may include, but is not limited to, preparing at least one non-woven polymer layer, where the at least one non-woven polymer layer includes a top surface opposite a substantially planar and parallel bottom surface. In another illustrative embodiment, the method may include, but is not limited to, preparing at least one paper layer, where the paper layer includes a top surface opposite a substantially planar and parallel bottom surface, and where both of the at least one non-woven polymer layer and the at least one paper layer are configured to allow at least one root of at least one seed to penetrate through both of the at least one non-woven polymer layer and the at least one paper layer. In another illustrative embodiment, the method may include, but is not limited to, bonding one of the bottom surface or the top surface of the at least one paper layer to one of the bottom surface or the top surface of the at least one non-woven polymer layer.

A planting method is disclosed, in accordance with one or more embodiments of the present disclosure. In one illustrative embodiment, the method may include, but is not limited to, preparing a layer of soil. In another illustrative embodiment, the method may include, but is not limited to, positioning a biodegradable layered composite on top of the prepared soil, where the biodegradable layered composite includes at least one non-woven polymer layer having a top surface opposite a substantially planar and parallel bottom surface bonded to at least one paper layer having a top surface opposite a substantially planar and parallel bottom surface. In another illustrative embodiment, the method may include, but is not limited to, planting at least one seed external to the biodegradable layered composite. In another illustrative embodiment, the method may include, but is not limited to, covering the at least one seed with a weed-free media. In another illustrative embodiment, the method may include, but is not limited to, watering the at least one seed, where the biodegradable layered composite allows for at least one root of the at least one seed to penetrate through both of the at least one non-woven polymer layer and the at least one paper layer of the biodegradable layered composite.

### BRIEF DESCRIPTION OF THE DRAWINGS

The numerous advantages of the disclosure may be better understood by those skilled in the art by reference to the accompanying figures in which:

FIG. 1 illustrates a conceptual view of at least one root penetrating through a biodegradable layered composite, in accordance with one or more embodiments of the present disclosure.

FIGS. 2A-2D illustrate photographs of the biodegradable layered composite following an ultrasonic bonding process, in accordance with one or more embodiments of the present disclosure.

FIGS. 3A-3D illustrate photographs of the biodegradable layered composite following a thermal bonding process, in accordance with one or more embodiments of the present disclosure.

FIG. 4 illustrates a photograph of the biodegradable layered composite used to grow a crop, in accordance with one or more embodiments of the present disclosure.

FIG. 5 illustrates a photograph of the biodegradable layered composite following a removal from the soil, in accordance with one or more embodiments of the present disclosure.

FIG. 6 illustrates a comparison of weed growth when using the biodegradable layered composite versus weed growth when using bare soil, in accordance with one or more embodiments of the present disclosure.

FIG. 7 illustrates a perspective view of a planting process utilizing the biodegradable layered composite, in accordance with one or more embodiments of the present disclosure.

FIG. 8A illustrates a pictorial view of a planting process utilizing the biodegradable layered composite on a commercial scale, in accordance with one or more embodiments of the present disclosure.

FIG. 8B illustrates a pictorial view of a planting process utilizing the biodegradable layered composite on a garden scale, in accordance with one or more embodiments of the present disclosure.

FIGS. 9A-9C illustrate perspective views of the biodegradable layered composite formed into a pot, in accordance with one or more embodiments of the present disclosure.

FIG. 10A-10C illustrate perspective views of the biodegradable layered composite formed into a pouch, in accordance with one or more embodiments of the present disclosure.

FIG. 11 illustrates a flow diagram of a method for planting with the biodegradable layered composite, in accordance with one or more embodiments of the present disclosure.

FIG. 12 illustrates a flow diagram of a method for making the biodegradable layered composite, in accordance with one or more embodiments of the present disclosure.

### DETAILED DESCRIPTION

Reference will now be made in detail to the subject matter disclosed, which is illustrated in the accompanying drawings. The present disclosure has been particularly shown and described with respect to certain embodiments and specific features thereof. The embodiments set forth herein are taken to be illustrative rather than limiting. It should be readily apparent to those of ordinary skill in the art that various changes and modifications in form and detail may be made without departing from the spirit and scope of the disclosure.

In general, weeds are consistently the top management concern among organic farmers, particularly for direct-seeded crops planted at high densities in narrow rows. For these crops, like carrots, leafy greens, strawberries, and cut flowers, it is not feasible to use plastic mulch films or landscape fabrics to control weeds because the number of plant holes cut into the membrane would render it useless. As a result, hand weeding is inevitable in these crops and represents a significant direct cost and opportunity cost to farmers and gardeners.

Current biobased and compostable materials (BCMs), including paper and bioplastics, lack the durability and functionality of the conventional plastics they aim to replace. The common value proposition of BCMs is that they are a renewable and sustainable alternative to plastic, which is of growing customer interest given concerns about the environmental fate of plastics. Currently, most agricultural and garden plastic is sent to the landfill or burned, and very little is recycled. Unfortunately, the performance of BCMs is often inferior to plastics yet the cost is nearly always greater due to the higher cost of biobased raw materials. Some customers, compelled by the negative effects of plastic, are willing to accept this tradeoff. However, this is not a scalable strategy for replacing plastics in the market.

Accordingly, embodiments of the present disclosure are directed to curing one or more of the shortfalls of previous approaches identified above.

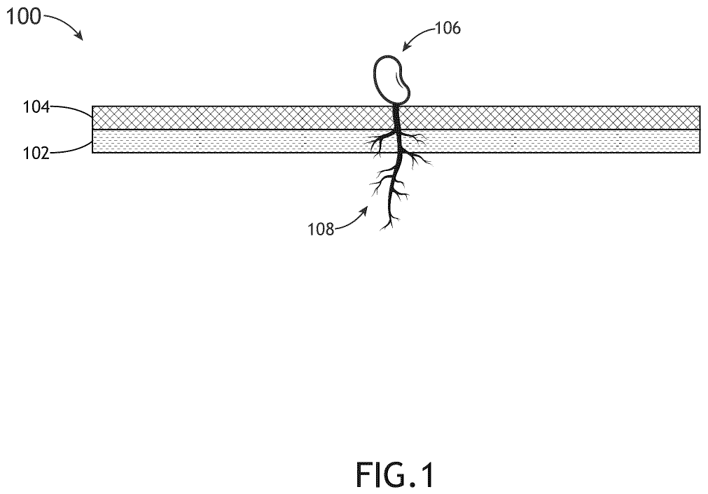

FIGS. 1 through 12 generally illustrate embodiments of a biodegradable layered composite and methods of manufacture and application.

FIG. 1 illustrates a conceptual view of the biodegradable layered composite 100, in accordance with one or more embodiments of the present disclosure. In embodiments, the biodegradable layered composite 100 may include at least a first layer 102 and at least a second layer 104. For example, the first layer 102 may include a non-woven polymer layer 102 having a top surface opposite a substantially planar and parallel bottom surface. By way of another example, the second layer 104 may include a paper layer 104 having a top surface opposite a substantially planar and parallel bottom surface. In embodiments, both the non-woven polymer layer 102 and the paper layer 104 of the biodegradable layered composite 100 allow for at least one root 108 of at least one seed 106 to penetrate through both the non-woven polymer layer 102 and the paper layer 104.

In embodiments, the non-woven polymer layer 102 may include at least one of a polylactide, polylactic acid, polyhydroxyalkanoates, polycaprolactones, polyhydroxybutyrates, cellulose esters, polybutylene succinates, polyamides, polyethylene, polypropylene, or polyester material. For example, the nonwoven polymer layer 102 may include a spunbond nonwoven polylactic acid (PLA) layer 104 (e.g., 30 g/m²). The spunbond PLA layer 102 may exhibit a mechanical strength, among other characteristics, which helps to physically suppress weed growth. It is noted herein that the 30 g/m² weight basis is not limiting, however, this may be a desired weight to balance the permeability for crop root growth and strength for suppressing weed shoot growth. It is further noted herein that the spunbond PLA layer 102 may maintain its stability in soil while providing weed suppression for at least one year, and once removed from the field, can be quickly biodegraded under commercial composting conditions.

In embodiments, the spunbond PLA layer 102, when acting on its own, may not serve as a functional weed barrier due to the fact that it may transmit an undesirable amount of light, allowing for weeds to germinate and grow beneath it and slowly push up over time. Further, the spunbond PLA layer 102 may be hydrophobic and not optimized for crop seedling establishment because it wicks moisture away from the at least one seed 106 placed on top of it. For instance, a surface of the spunbond PLA layer 102 may be glossy and lack a wet tackiness, which may cause the at least one seed 106 and weed-free media to erode from the surface of the biodegradable layered composite 100 during wind and rain events.

In embodiments, the paper layer 104 may help resolve the shortcomings observed by the first layer when acting alone. In embodiments, the at least one paper layer may be formed from cellulose-based materials or recycled paper. For example, the at least one paper layer 104 may include a kraft crepe paper layer 104 (e.g., 75 g/m²). By way of another example, the paper layer 104 may exhibit opaque characteristics causing a reduction of light transmittance through the biodegradable layered composite 100, which prevents growth of any weeds germinating below. By way of another example, the paper layer 104 may be highly hydrophilic and increase moisture around the seeds improving seedling establishment and vigor. In a further example, the paper layer 104 may have a wet tack which may increase adhesion between seeds, weed-free media, and the weed barrier during wind and rain events.

In embodiments, the paper layer 104 is biodegradable. For example, the paper layer 104 may be configured to biodegrade in soil or weed-free media within, but not limited to, 30-60 days. For instance, the time it takes for the paper layer 104 to biodegrade may vary based on the surrounding environmental conditions; however, the critical functions of the cellulose may no longer be needed after that point since the seedlings have been established and their canopy may be capable of preventing light from penetrating below the remaining non-woven polymer layer 102 of spunbond PLA. It is further noted that a weed-free media layer may be applied on top of the biodegradable layered composite 100, which will also assist in preventing light from penetrating below the biodegradable layered composite 100.

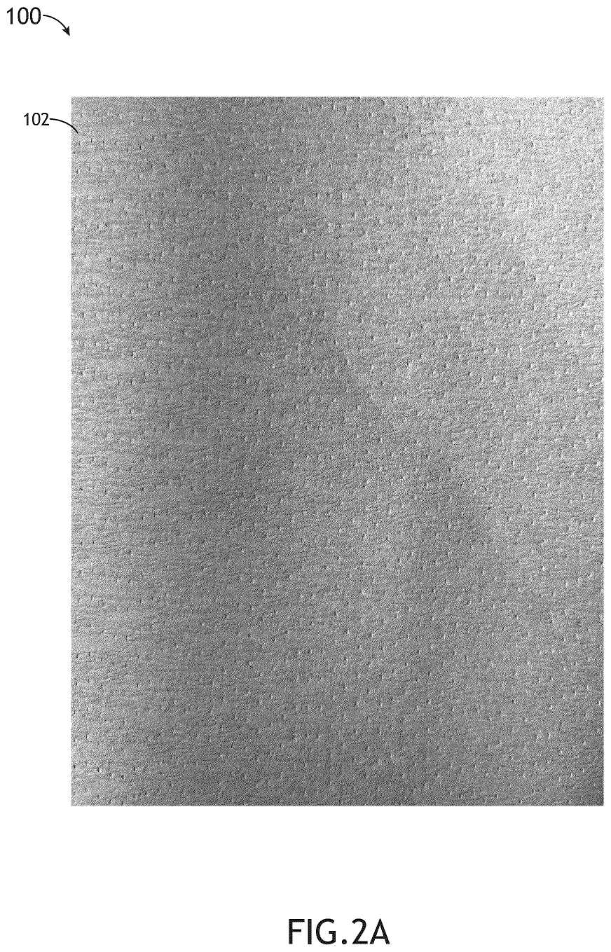

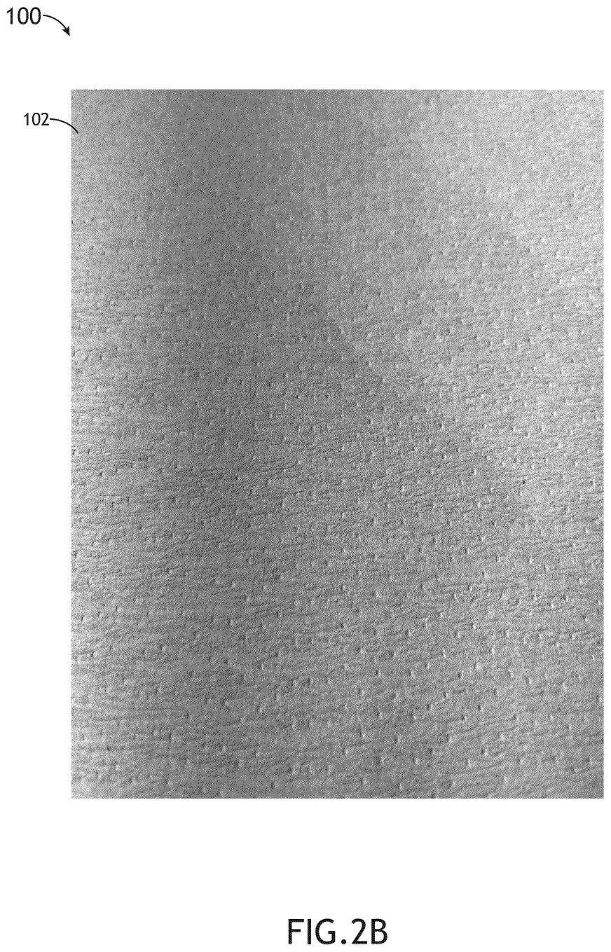

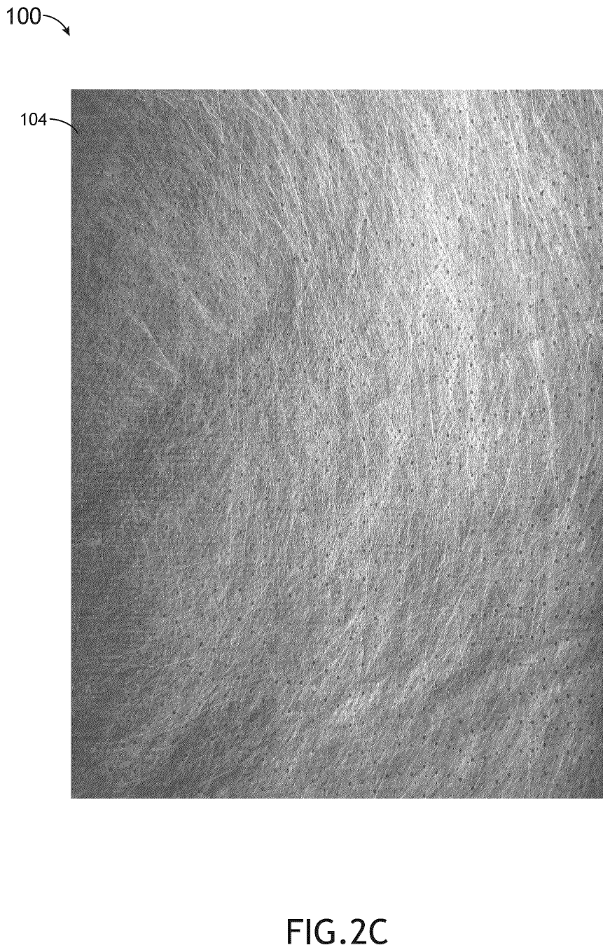

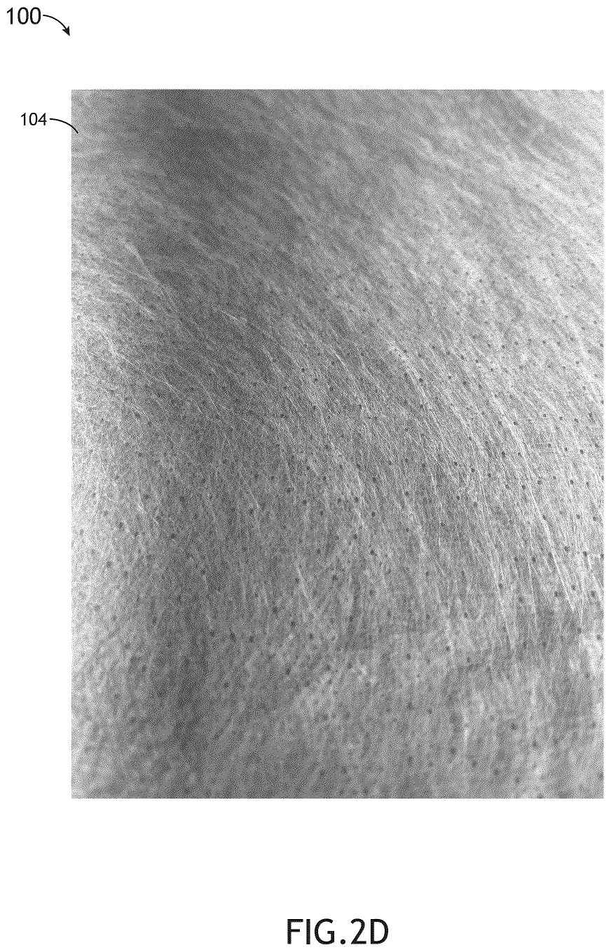

FIGS. 2A-2D illustrate photographs of the biodegradable layered composite 100 following an ultrasonic bonding process, in accordance with one or more embodiments of the present disclosure.

In embodiments, the paper layer 104 may be bonded to the non-woven polymer layer 102 via an ultrasonic bonding process. For example, either a top or bottom surface of the paper layer 104 may be positioned proximate to either a top or bottom surface of the non-woven PLA layer 102. By way of another example, ultrasonic bonding of the two layers 102, 104 may be achieved through the application of high-frequency mechanical vibrations creating localized heat. The localized heat causes the polymer fibers of the non-woven PLA layer 102 to partially melt and adhere to the paper layer 104, and upon cooling, a secure bond is formed. In response to the ultrasonic bonding process, one or more patterned point bonds may form across a surface of the paper layer 104 or the PLA layer 102.

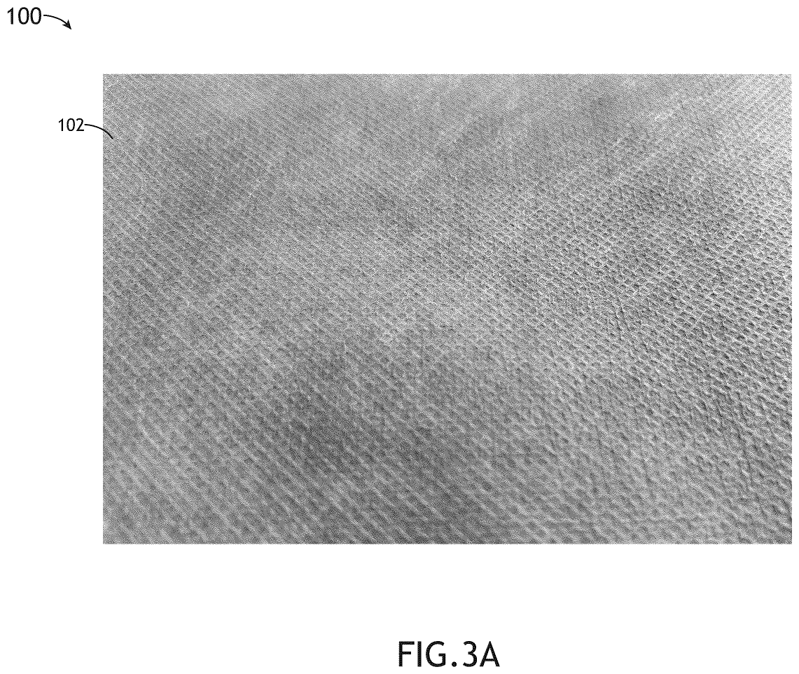

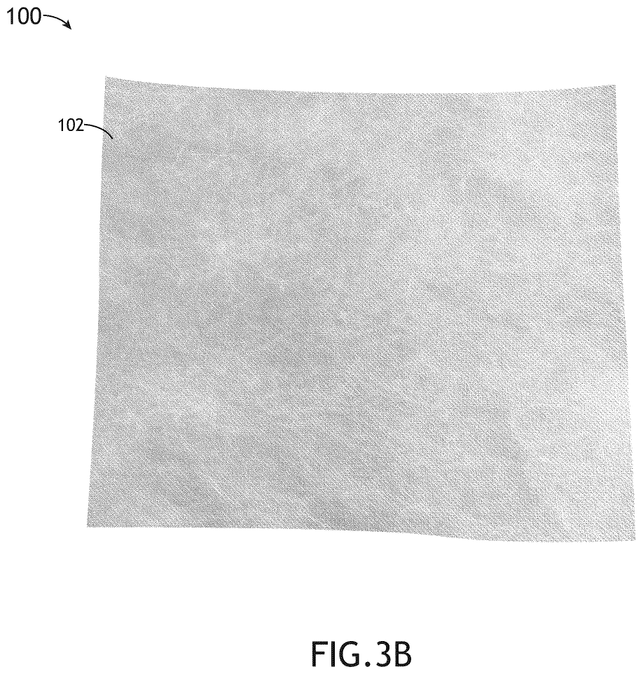

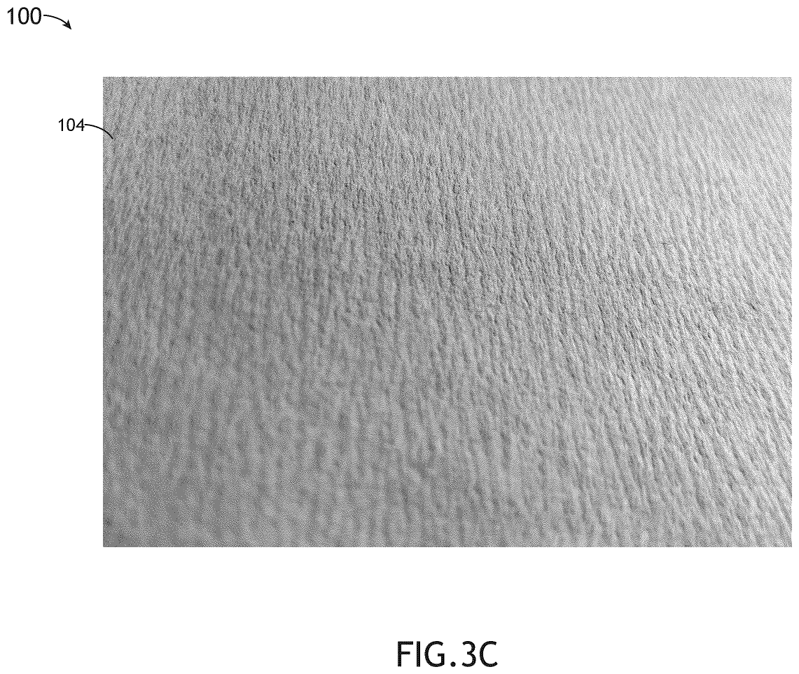

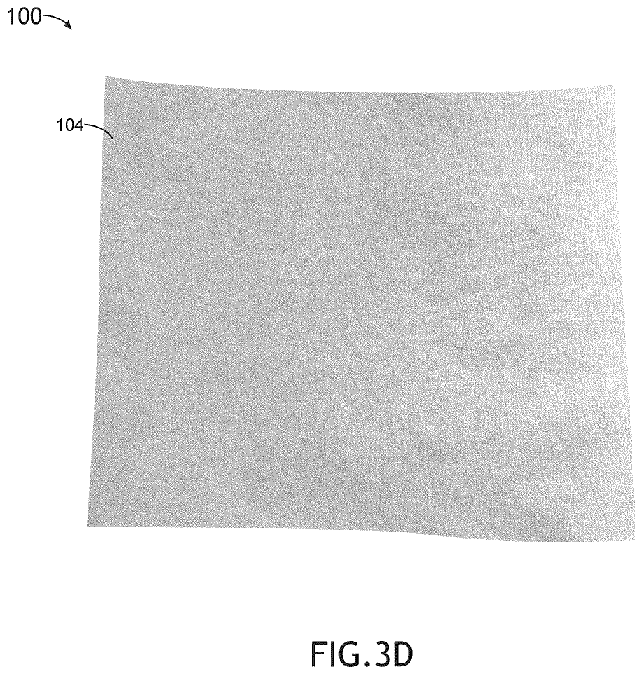

FIGS. 3A through 3D, illustrate photographs of the biodegradable layered composite 100 following a thermal bonding process, in accordance with one or more embodiments of the present disclosure.

In embodiments, the paper layer 104 may thermally bond to the non-woven polymer layer 102 via a non-woven calendering process. Calender bonding of the two layers may be achieved through high temperature and pressure at high speeds where the first and second layers 102, 104 are passed through heated rollers. As the materials come into contact with the heated surface, the polymer fibers may partially melt and adhere to the paper layer 104 upon cooling. In response to the calender bonding process, one or more patterned point bonds may form across a surface of the paper layer 104 or the PLA layer 102.

It is noted herein that bonding of the paper layer 104 and the non-woven polymer layer 102 are not limited to an ultrasonic bonding process or a calender bonding process as disclosed above; however, the bonding process may include, but is not limited to, an adhesive bonding, mechanical bonding, lamination, or other like bonding processes known in the art. It is further noted that the bonding process used to form the biodegradable layered composite 100 may bond the paper layer 104 and the non-woven PLA layer 102 without compromising the one or more characteristics of each layer.

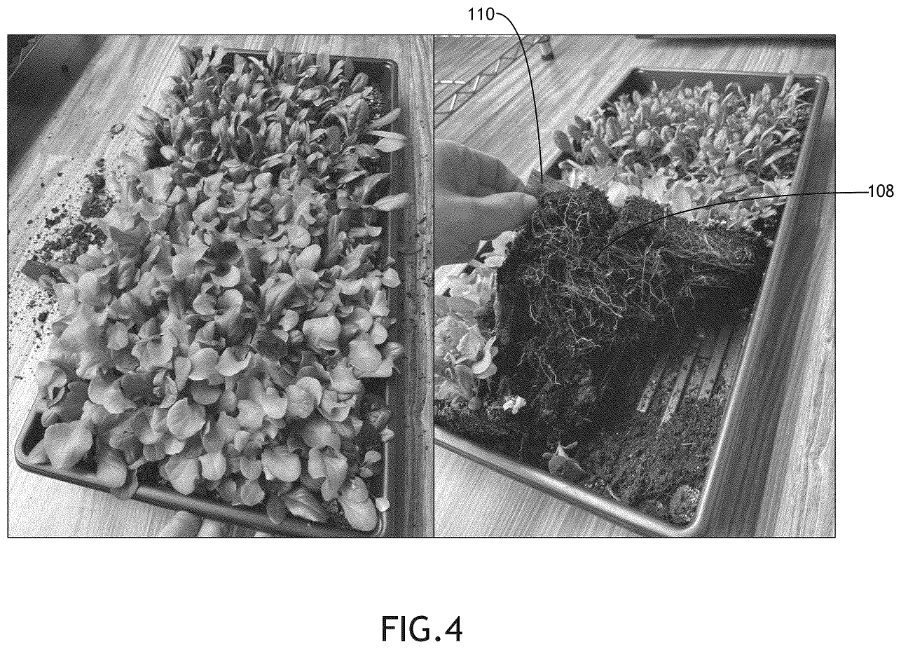

FIG. 4 illustrates a photograph of the biodegradable layered composite used to grow a crop, in accordance with one or more embodiments of the present disclosure.

In embodiments, crop roots are able to grow through the biodegradable layered composite 100 from above, while weeds are suppressed below. For example, the biodegradable layered composite 100 may be used for growing tap and fibrous root systems through both the non-woven polymer layer 102 and the paper layer 104 of the biodegradable layered composite 100.

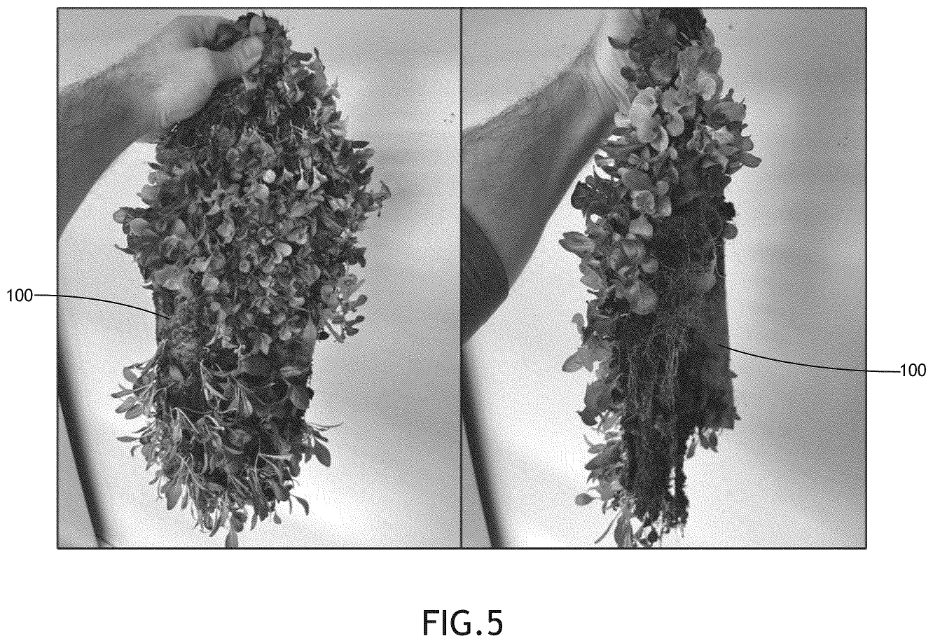

FIG. 5 illustrates a perspective view of the biodegradable layered composite 100 following a removal from the soil, in accordance with one or more embodiments of the present disclosure. In embodiments, the biodegradable layered composite 100 may remain intact throughout a growing season. For example, during the harvest season, the biodegradable layered composite 100 may be used to remove a crop from the field to aid in harvest or to preserve the freshness of a crop by delaying a harvest cut. By way of another example, a crop that is grown with the biodegradable layered composite 100 may remain intact and rooted through the first and second layers 102, 104 of the biodegradable layered composite 100 upon removal from the soil.

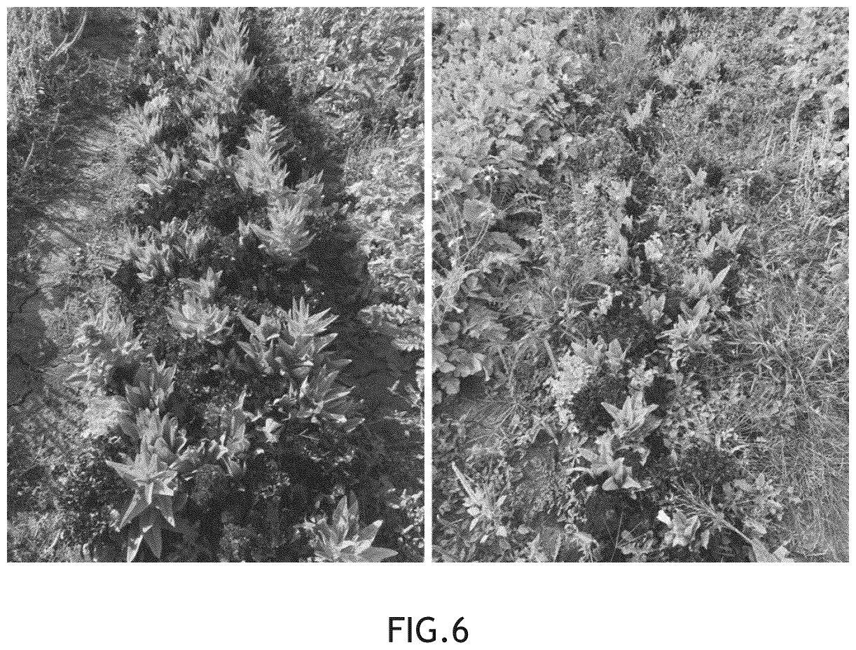

FIG. 6 illustrates a comparison of weed growth when using the biodegradable layered composite 100 (pictured on the left) versus weed growth when using bare soil (pictured on the right), in accordance with one or more embodiments of the present disclosure. As shown in FIG. 6, the weed growth surrounding the crops utilizing the biodegradable layered composite 100 is significantly less evident as opposed to the crops planted in the bare soil.

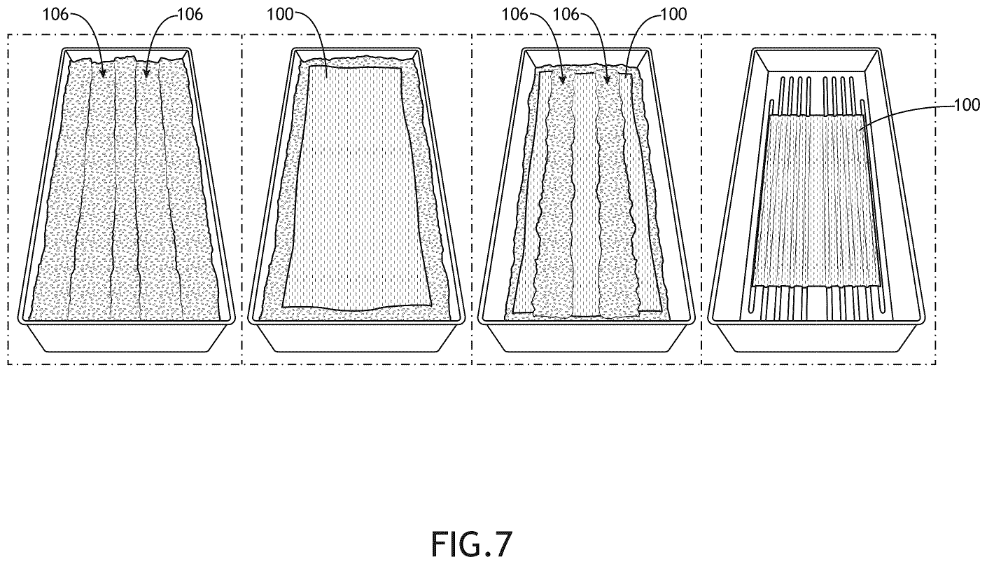

FIG. 7 illustrates a perspective view of a planting process utilizing the biodegradable layered composite 100, in accordance with one or more embodiments of the present disclosure. In embodiments, a layer of soil is prepared (first image). For example, the layer of soil may include one or more furrows 110 prepared to a desired depth (e.g., 1 inch). It is noted herein that using at least one furrow 110 may reduce the likelihood of weed-free media washing off the biodegradable layered composite 100 during intense rainfall events or if planted on a significant slope. In embodiments, the biodegradable layered composite 100 may be positioned on top of the layer of soil (second image), where it is to be seeded and watered. In embodiments, the one or more furrows 110 may be covered with weed-free media (third image). In embodiments, the biodegradable layered composite 100 is able to conform to the contours of the prepared layer soil and one or more furrows 110 (fourth image). For example, a dimpled pattern may be formed on the paper layer 104, which may serve to stabilize the biodegradable layered composite 100 between the one or more furrows 110 once the paper layer 104 has been degraded by microbes in the one or more furrows 110.

It is noted herein that after seedling establishment, watering may be reduced or eliminated since the biodegradable layered composite 100 reduces evaporative water loss from soil and a portion of rainwater may percolate through the biodegradable layered composite 100. For example, during a growing season, weeds may be suppressed beneath the biodegradable layered composite 100, eliminating the need for hand weeding. At the end of the growing season, the biodegradable layered composite 100 may be lifted from the soil and used to aid in harvest (e.g., as shown in FIG. 5) or left in the field to be reused for additional plantings.

It is further noted herein that one or more portions of the biodegradable layered composite 100 may not be covered by the weed-free media layer; however, the paper layer 104 may remain in place throughout the growing season (e.g., not degrade) because of the bonding process and because the PLA layer 102 reduces contact between the paper layer 104 in the soil.

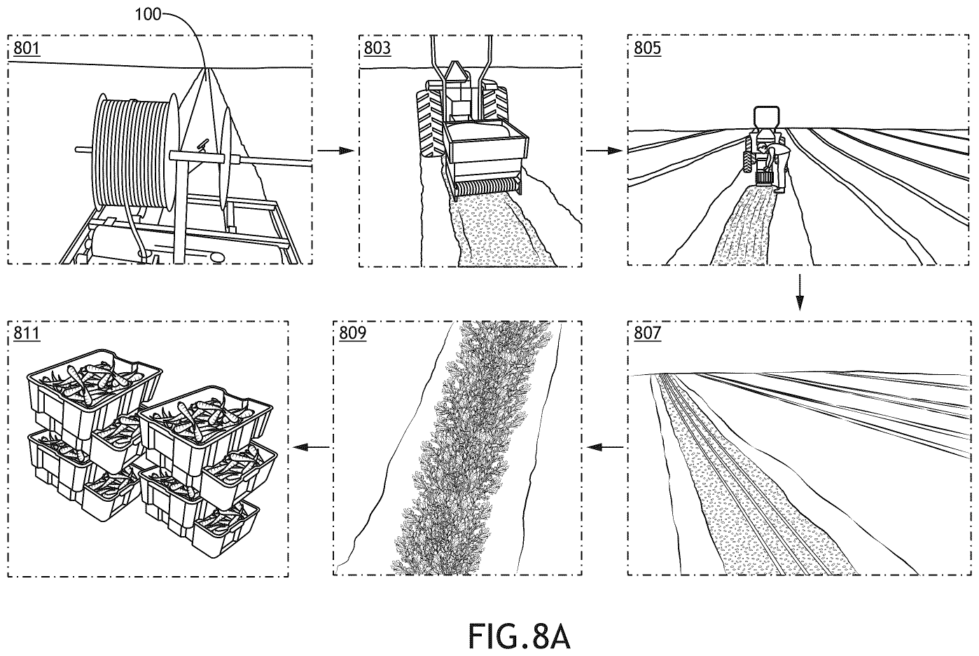

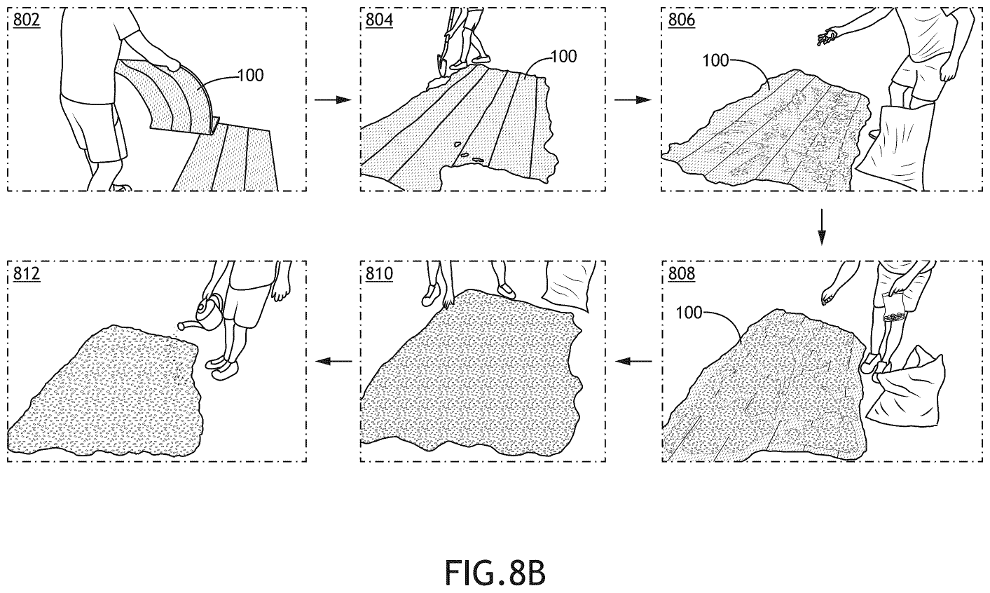

FIG. 8A illustrates a pictorial view of a planting process utilizing the biodegradable layered composite on a commercial scale, in accordance with one or more embodiments of the present disclosure. In embodiments, the biodegradable layered composite 100 may be applied over the top of a flat ground. For example, the commercial scale production process may begin with a step 801 of preparing the bed. By way of another example, the commercial scale production process may include a step 803 of applying a mulch to the prepared bed. By way of another example, the commercial scale production process may include a step 805 of laying weed-free media over the mulch. By way of another example, the commercial scale production process may include a step 807 of seeding. By way of another example, the commercial scale production process may include a step 809 of crop growth. By way of another example, the commercial scale production process may include a step 811 of harvesting the crop.

FIG. 8B illustrates a pictorial view of a planting process utilizing the biodegradable layered composite on a garden scale, in accordance with one or more embodiments of the present disclosure. In embodiments, the garden scale planting process may be applied over the top of a flat ground. For example, the garden scale planting process may include a step 802 of applying the biodegradable layered composite 100 over the top of a flat ground. By way of another example, the garden scale planting process may include a step 804 of covering the edges of the biodegradable layered composite 100 with soil. By way of another example, the garden scale planting process may include a step 806 of applying a mulch over the top of the prepared biodegradable layered composite 100. By way of another example, the garden scale planting process may include a step 808 of disposing at least one seed 106 external to the biodegradable layered composite 100. By way of another example, the garden scale planting process may include a step 810 of covering the at least one seed 106 with a layer of weed-free media. By way of another example, the garden scale planting process may include a step 812 of watering the at least one seed.

It is noted herein that the biodegradable layered composite 100 may be effectively utilized with specific crops such as, but not limited to, carrot, lettuce, arugula, beets, kale, strawberry, and the like. For example, benefits may include weed suppression (e.g., greater than 90% in all crops), reduction in labor (e.g., greater than 95%), increased soil moisture and beneficial microbial abundance, and increased crop growth and yield, as shown in FIG. 6. Moreover, the biodegradable layered composite 100 may increase the establishment success and early vigor of directly seeded crops (e.g., up to 33%) even in the absence of weeds, which is likely the result of the water holding capacity of the biodegradable layered composite 100.

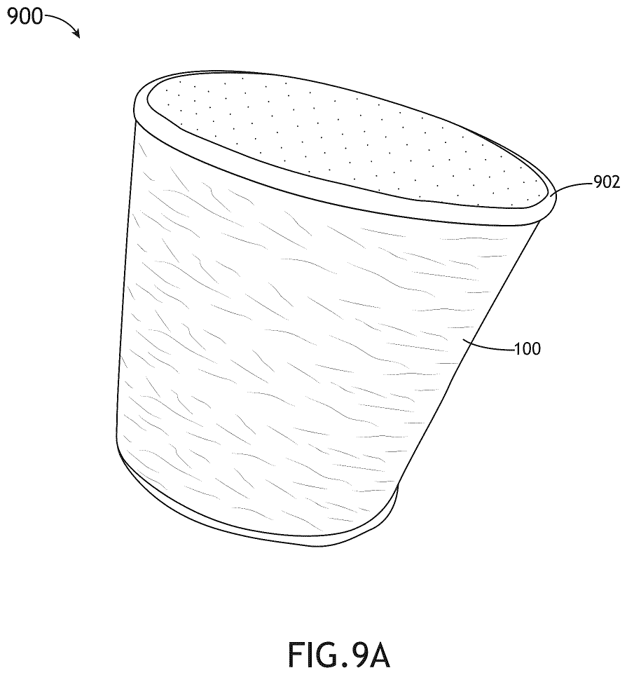

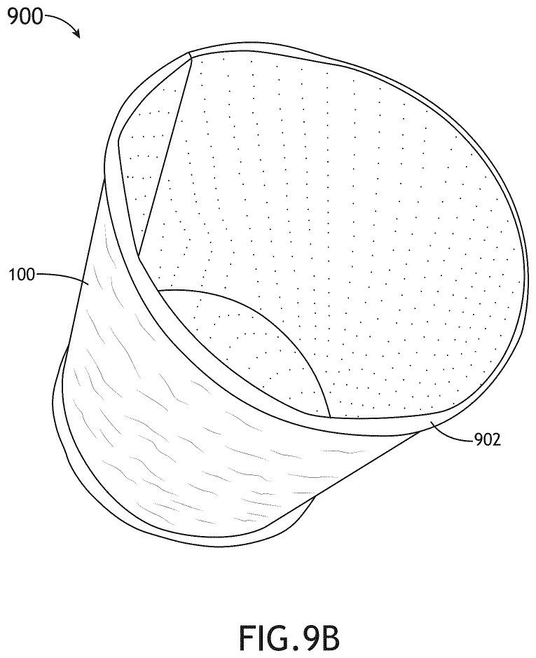

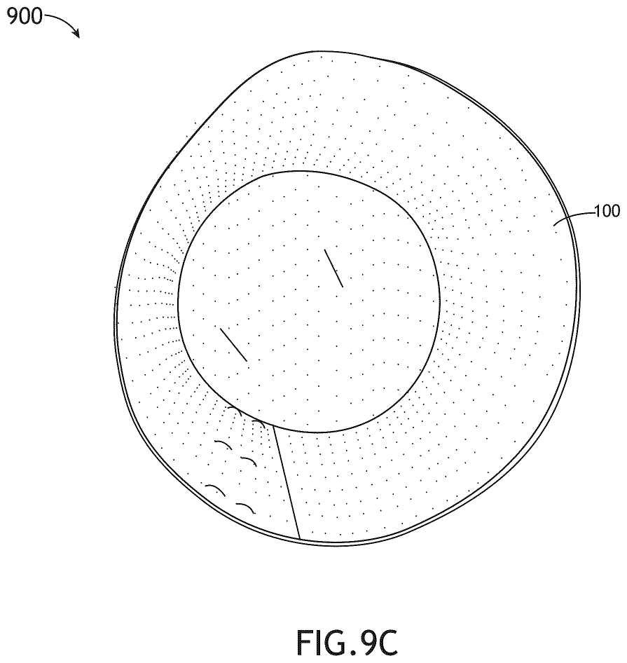

FIGS. 9A through 9C illustrate a perspective view of the biodegradable layered composite 100 formed into a container 900, in accordance with one or more embodiments of the present disclosure.

In embodiments, the container 900 is made from the biodegradable layered composite material 100. For example, the container 900 may take the shape of at least one of a cone, pyramid, conical frustum, or frustum of a pyramid. By way of another example, the shape may include an overlapping surface that provides a structural backbone in the longitudinal direction.

In embodiments, the container may include a plurality of micro perforations uniformly distributed within the biodegradable layered composite material 100. For example, the plurality of micro perforations may promote a natural air-pruning of the at least one root 108. It is noted herein that air pruning is a horticultural technique designed to encourage the development of a fibrous and highly branched root system in plants. The process involves exposing roots to air, which causes the tips of the roots to dry out and die. This natural pruning of the roots breaks apical dominance, disrupts auxin biosynthesis, and stimulates the plant to produce new lateral roots, resulting in a more robust, fibrous, dense, and well-branched root structure. As a result, the air pruned root system may be more efficient in water and nutrient uptake from the soil and less susceptible to transplant shock when planted in a field or landscape.

It is further noted herein that air pruning may be particularly beneficial in greenhouse production and commercial propagation, where plants are grown in pots or containers before being removed from the pot and transplanted into a garden, farm, landscape, or forest soil.

In embodiments, the container 900 may include a bottom surface and a top surface. For example, the top surface may include a rim 902 that forms the perimeter of an opening in the container 900. The bottom surface may have a smaller surface area and be offset from the top opening of the container 900. By way of another example, the rim 902 may be curled down and rolled to form a lip, which surrounds the opening of the container 900.

In embodiments, the container 900, formed from the biodegradable layered composite 100, is configured to be used as a plant pot. For example, the plant pot may include a plurality of micro perforations to allow for exposure of the at least one root 108 to air. By way of another example, the plant pot may be made from compostable materials such that it can be planted directly in the soil. In embodiments, roots that attempt to grow through the plant pot are air pruned, but once placed in soil, roots that grow through the biodegradable layered composite 100 may continue into the surrounding soil and are not pruned. By way of another example, as roots continue to grow and expand through the biodegradable layered composite 100, the pot will physically and biologically degrade, resulting in a reduction in plastic pot waste and an easier transplanting process for the user.

In embodiments, the plant pot includes an additional outer wall, forming a double-walled container. For example, the double walled container may include an air gap between a surface of the additional outer wall and a surface of the plant pot. By way of another example, the air gap formed between the additional outer wall and a surface of the plant pot may facilitate air pruning of at least one root 108 when plants are grown within the plant pot. By way of another example, the air gap may provide natural ventilation and help regulate a temperature of the plant for optimal plant growth. It is noted herein that the additional outer wall may be used for one or more additional purposes including, but not limited to, aesthetic appeal, marketing, and communication.

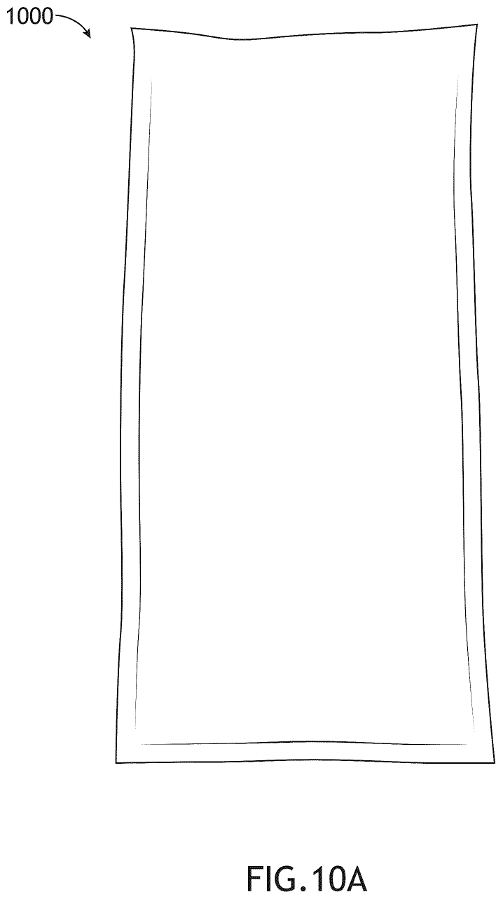

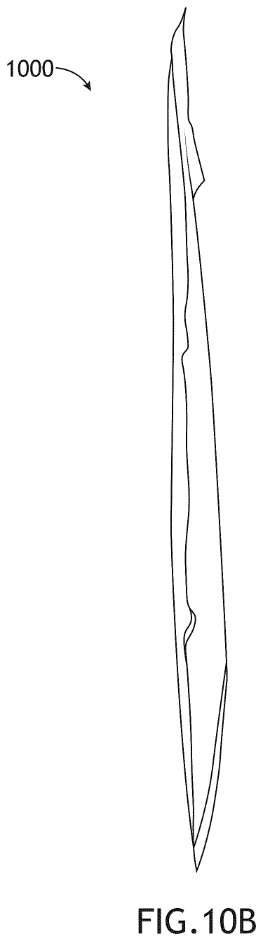

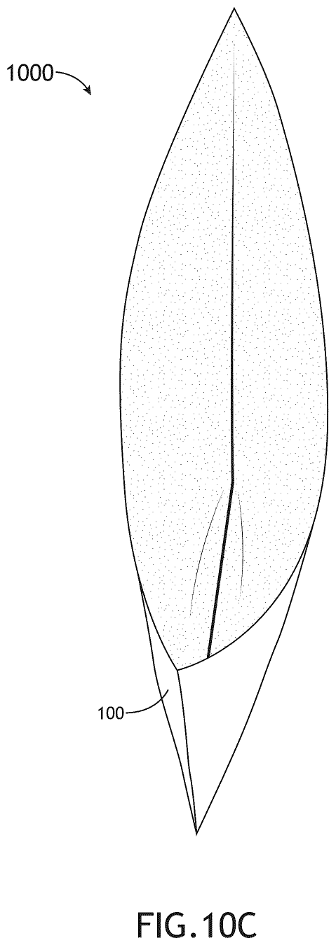

FIGS. 10A through 10C illustrate a perspective view of the biodegradable layered composite 100 formed into a pouch 1000, in accordance with one or more embodiments of the present disclosure.

In embodiments, at least a portion of a first end of the biodegradable layered composite 100 is folded and coupled to at least a portion of a second end of the biodegradable layered composite 100. For example, at least two side portions of the folded biodegradable layered composite 100 may be sealed, creating a pouch 1000. In embodiments, the pouch 1000 may include an opening configured to receive a filling of material. For example, the filling of material may be plant-based and compostable, and the filling may include one or more properties associated with water wicking or water retention. By way of another example, the one or more characteristics of the filling are configured to facilitate an imbibition of water into the at least one seed 106 for germination of the at least one seed 106. In embodiments, once the pouch is filled with the filling material, all four edges of the pouch may be sealed to secure the filling within the pouch 1000.

It is noted herein that the pouch 1000 may preferably be used with planting microgreens. Microgreens are the young seedlings of vegetables and herbs typically harvested within one to three weeks of planting. Microgreens are usually grown in controlled environments such as, but not limited to, greenhouses, vertical farms, and hydroponic systems. Some microgreens are seeded directly into soil or soilless media, including peat, coco coir, or compost. However, many users prefer to seed microgreens on soilless grow mats to help facilitate cleaner production and harvesting of produce. Most importantly, grow mats provide users the option to eliminate cutting or harvesting the microgreens and instead place the grow mat and living microgreen into a retail clamshell container for sale.

It is further noted that cutting microgreens to harvest releases ethylene, a plant hormone that accelerates plant tissue decay, and desiccates plant tissue leading to wilting. Grow mats may eliminate the potential for this decay and wilt, thereby extending the shelf life of microgreens and reducing food waste. Grow mats may also eliminate the need for soil, weed-free media, or soilless media that can harbor microbes that accelerate decay and possibly compromise food safety. However, current grow mats for microgreens production either do not perform well compared to traditional soilless media, are not biobased and compostable, or are not durable enough to be moved from production systems to retail clamshell containers for sale.

In embodiments, the pouch 1000 may include a plurality of micro perforations uniformly distributed within the biodegradable layered composite 100. For example, the porous nature of the biodegradable layered composite 100 may facilitate the growth of at least one root through both the first layer 102 and the second layer 104 of the biodegradable layered composite 100 and materials therein. By way of another example, the pouch 1000 may be packaged in a retail clamshell container and available for sale and consumption. By way of another example, the pouch 1000 may provide a longer shelf-life to the at least one seed 106 due to its water holding capacity.

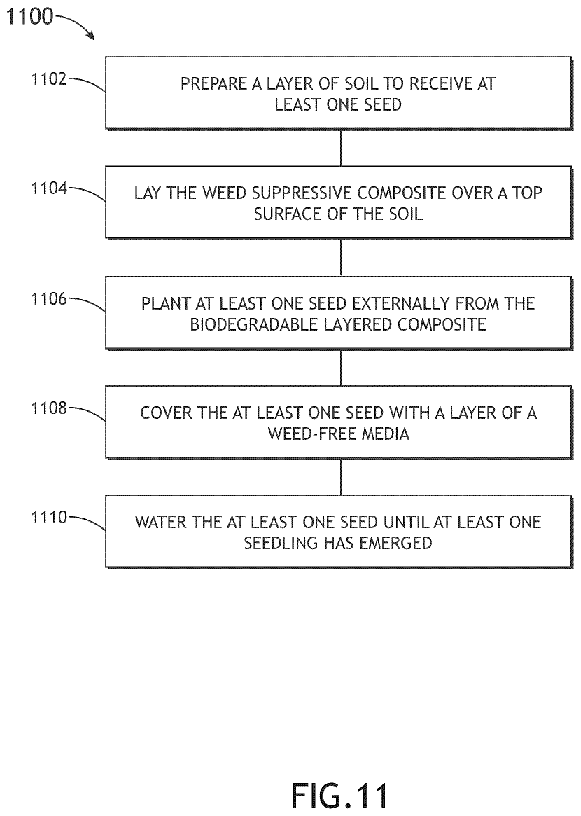

FIG. 11 illustrates a flow diagram of a method 1100 for planting with the biodegradable layered composite 100, in accordance with one or more embodiments of the present disclosure.

In a step 1102, the method may include, but is not limited to, preparing a layer of soil to receive at least one seed 106. In embodiments, one or more seed furrows 110 may be prepared in the layer of soil.

In a step 1104, the method 1100 may include, but is not limited to, positioning the biodegradable layered composite 100 over a top surface of the prepared soil. In embodiments, the biodegradable layered composite 100 may receive an amount of water that is sufficient to help shape the biodegradable layered composite 100 to the contours of the one or more prepared furrows 110.

In a step 1106, the method 1100 may include, but is not limited to, planting at least one seed 106 externally from the biodegradable layered composite 100. In some embodiments, the at least one seed 106 may be planted in the one or more prepared furrows 110.

In a step 1108, the method 1100 may include, but is not limited to, covering the at least one seed 106 with a layer of compost or other weed-free media (e.g., coco coir).

In a step 1110, the method 1100 may include, but is not limited to, watering the at least one seed 106 until at least one seedling has emerged. In embodiments, the at least one seedling produces at least one root 108. For example, the at least one root 108 may penetrate through both the paper layer 104 and the non-woven PLA layer 102 of the biodegradable layered composite 100.

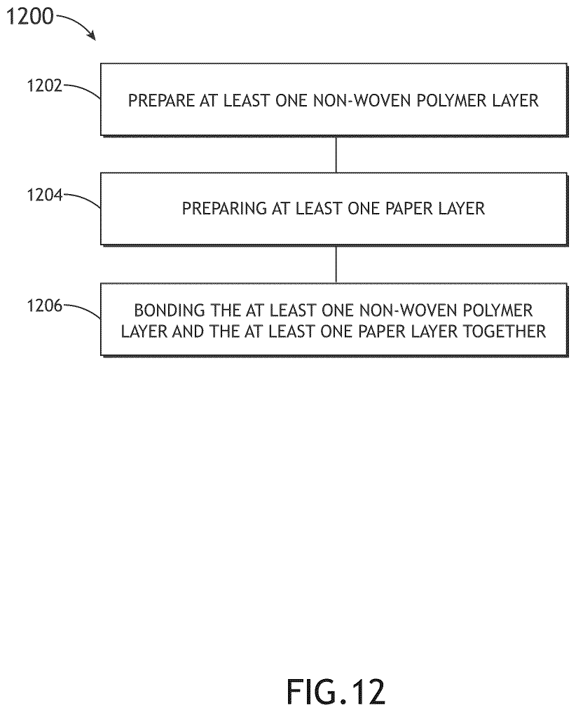

FIG. 12 illustrates a flow diagram of a method 1200 for making the biodegradable layered composite 100, in accordance with one or more embodiments of the present disclosure.

In a step 1202, the method 1200 may include, but is not limited to, preparing at least one non-woven polymer layer 102. For example, the at least one nonwoven polymer layer 102 may include a spunbond nonwoven polylactic acid (PLA) layer 102.

In a step 1204, the method 1200 may include, but is not limited to, preparing at least one paper layer 104. For example, the at least one paper layer 104 may include a crepe paper layer 104.

In a step 1206, the method 1200 may include, but is not limited to, combining the at least one nonwoven polymer layer 102 with the at least one paper layer 104. In embodiments, the at least one nonwoven polymer layer 102 and the at least one paper layer 104 may be combined via a bonding process. For example, the bonding process may include an ultrasonic bonding process where bonding of the two layers 102, 104 may be achieved through the application of high-frequency mechanical vibrations creating localized heat. It is noted herein that the method of combining the at least one nonwoven polymer layer 102 and the at least one paper layer 104 via a bonding process is not limiting and may include one or more other methods of combination such as, but not limited to, thermal bonding, lamination, sewing, adhesives, or the like.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken as limiting.

The previous description is presented to enable one of ordinary skill in the art to make and use the invention as provided in the context of a particular application and its requirements. As used herein, directional terms such as “top,” “bottom,” “over,” “under,” “upper,” “upward,” “lower,” “down,” and “downward” are intended to provide relative positions for purposes of description, and are not intended to designate an absolute frame of reference. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

The herein described subject matter sometimes illustrates different components contained within, or connected with, other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected,” or “coupled,” to each other to achieve the desired functionality, and any two components capable of being so associated can also be viewed as being “couplable,” to each other to achieve the desired functionality. Specific examples of couplable include but are not limited to physically mateable and/or physically interacting components and/or wirelessly interactable and/or wirelessly interacting components and/or logically interacting and/or logically interactable components.

Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” and the like). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, and the like” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, and the like). In those instances where a convention analogous to “at least one of A, B, or C, and the like” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, and the like). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes. Furthermore, it is to be understood that the invention is defined by the appended claims.

1. A biodegradable layered composite comprising:
at least one non-woven polymer layer comprising a top surface opposite a substantially planar and parallel bottom surface; and
at least one paper layer disposed on the at least one non-woven polymer layer and comprising a top surface opposite a substantially planar and parallel bottom surface, wherein one of the bottom surface or the top surface of the at least one paper layer is bonded to one of the bottom surface or the top surface of the at least one non-woven polymer layer,
wherein both of the at least one non-woven polymer layer and the at least one paper layer are configured to allow at least one root of at least one seed to penetrate through both of the at least one non-woven polymer layer and the at least one paper layer.

2. The biodegradable layered composite of claim 1, wherein the at least one paper layer is formed from cellulose-based materials or recycled paper.

3. The biodegradable layered composite of claim 1, wherein the at least one non-woven polymer layer comprises at least one of a polylactide, polylactic acid, polyhydroxyalkanoates, polycaprolactones, polyhydroxybutyrates, cellulose esters, polybutylene succinates, polyamides, polyethylene, polypropylene, or polyester material.

4. The biodegradable layered composite of claim 1, wherein at least a portion of a first end of the bonded at least one non-woven polymer layer and the at least one paper layer is configured to fold and couple to at least a portion of a second end of the bonded at least one non-woven polymer layer and the at least one paper layer, creating a pouch, wherein the pouch is configured to provide an opening for holding a material.

5. The biodegradable layered composite of claim 1, further comprising a plurality of micro perforations uniformly arranged throughout at least one of the bonded at least one non-woven polymer layer or the at least one paper layer.

6. The biodegradable layered composite of claim 4, wherein the opening of the pouch further comprises a filling having one or more characteristics, the one or more characteristics including at least one of water wicking or water retention.

7. The biodegradable layered composite of claim 6, wherein, once the filling has been added, the pouch and the filling are sealed on all four edges of the pouch to fully secure and contain the filling within the pouch.

8. The biodegradable layered composite of claim 6, wherein a material of the filling is plant-based and compostable.

9. The biodegradable layered composite of claim 6, wherein the one or more characteristics of the filling are configured to facilitate an imbibition of water into the at least one seed for germination of the at least one seed.

10. The biodegradable layered composite of claim 5, wherein the plurality of micro perforations is configured to facilitate a root growth through at least one of the bonded at least one non-woven polymer layer or the at least one paper layer.

11. The biodegradable layered composite of claim 1, wherein the bonded at least one non-woven polymer layer and the at least one paper layer are configured to form a container.

12. The biodegradable layered composite of claim 11, wherein the container has a shape in the form of at least one of a cone, pyramid, conical frustum, or frustum of a pyramid.

13. The biodegradable layered composite of claim 12, wherein the shape includes at least one overlapping surface configured as a structural backbone in a longitudinal direction.

14. The biodegradable layered composite of claim 11, wherein the container includes a plurality of micro perforations uniformly distributed throughout at least one of the non-woven polymer layer or the at least one paper layer.

15. The biodegradable layered composite of claim 12, wherein the frustum has a bottom surface opposite a substantially planar and parallel top surface, wherein the bottom surface has a smaller surface area and is offset from the top surface and a bottom rim.

16. The biodegradable layered composite of claim 15, wherein the top surface includes a rim, wherein at least a portion of the rim is curled down and rolled to form a lip.

17. The biodegradable layered composite of claim 11, wherein the container is configured to be used as a plant pot, wherein the plant pot provides an exposure of the at least one root to air.

18. The biodegradable layered composite of claim 17, wherein the plant pot further comprises an additional outer wall, forming a double-walled container.

19. The biodegradable layered composite of claim 18, wherein the additional outer wall comprises a heat sealable sleeve configured to surround the plant pot.

20. The biodegradable layered composite of claim 18, further comprising a cavity between a surface of the plant pot and an inner surface of the additional outer wall, forming an air gap.

21. The biodegradable layered composite of claim 20, wherein the air gap is configured to allow for air pruning of the at least one root of the at least one seed.

22. The biodegradable layered composite of claim 20, wherein the air gap is configured to provide natural ventilation and regulate temperature for optimal plant growth.

23. The biodegradable layered composite of claim 1, wherein the at least one paper layer is substantially free of a coating layer having an adverse effect on a porosity characteristic of the at least one paper layer.

24. The biodegradable layered composite of claim 1, wherein the at least one non-woven polymer layer and the at least one paper layer are thermally bonded together via a non-woven calendering process.

25. The biodegradable layered composite of claim 24, wherein a pattern of one or more point bonds are formed across a surface of the at least one paper layer in response to the non-woven calendering process.

26. The biodegradable layered composite of claim 25, wherein the pattern of the one or more point bonds comprises one or more dimples formed across at least one of the top surface or the bottom surface of the at least one paper layer in response to the non-woven calendering process.

27. The biodegradable layered composite of claim 1, wherein at least a portion of the at least one paper layer is configured to reduce light transmittance to prevent a growth of germinated weeds.

28. The biodegradable layered composite of claim 1, wherein at least a portion of the at least one non-woven polymer layer is hydrophobic.

29. The biodegradable layered composite of claim 1, wherein at least a portion of the at least one paper layer is hydrophilic.

30. The biodegradable layered composite of claim 1, wherein the at least one paper layer and the at least one non-woven layer are configured to biodegrade in at least one of soil or a weed-free media.

31. A method for manufacturing a biodegradable layered composite comprising:
preparing at least one non-woven polymer layer, the at least one non-woven polymer layer comprising a top surface opposite a substantially planar and parallel bottom surface;
preparing at least one paper layer, the at least one paper layer comprising a top surface opposite a substantially planar and parallel bottom surface; and
bonding one of the top surface or the bottom surface of the at least one paper layer to one of the bottom surface or the top surface of the at least one non-woven polymer layer, wherein both of the at least one non-woven polymer layer and the at least one paper layer are configured to allow at least one root of at least one seed to penetrate through both of the at least one non-woven polymer layer and the at least one paper layer.

32. The method of claim 31, further comprising:
providing at least one additive to the at least one paper layer, the at least one additive configured to improve at least one wet strength characteristic of the at least one paper layer.
